(19) United States
(12) Patent Application Publication
(10) Pub. No.: US 2004/0113412 A1
(43) Pub. Date: Jun. 17, 2004

(54) Multi-point seat belt

(76) Inventor: Giok Djien Go, Idstein (DE)

Correspondence Address: Dr. Ing. Giok Djien Go, Pfahlgrabenstr. 45,, D-65510, Idstein, DE

(21) Appl. No.: 10/690,741

(22) Filed: Oct. 10, 2003

Related U.S. Application Data
(62) Division of application No. 09/554,463, filed on Apr. 19, 2000.

(30) Foreign Application Priority Data
Nov. 10, 1998 (EP) 1 037 773 B1
Nov. 10, 1998 (DE) 197 49 780 C2

(51) Int. Cl. B60R 22/00

(52) U.S. Cl. 280/808

(57) ABSTRACT

A multi-point seat-belt includes two shoulder-belt portions, a lap-belt portion, master release-button, multi-attachment points and a belt-feeding device, which, when activated, moves the first shoulder-belt portion to extend across over the upper of the body of the passenger, when taking his seat. In conjunction with a main latch-plate plug-in connecting to a main buckle-assembly both shoulder-belt portions extend crosswise over the upper-part thereof in an X-shape and the lap-belt portion restrains the lower-part thereof.

Another belt-feeding device is adapted to the seat-design.

The user-friendliness is enhanced by one-click operation of the master release-button, which, when depressed, releases all latch-plates and returns the belt-feeding device to the home position.

In order to protect the passenger in a rollover-accident a safety bracket of another belt-feeding device blocks the first shoulder-belt portion in excess of a threshold value.

Serving as transition-products multi-point seat-belts are defined by conventional three-point seat-belts and new parts.

### CROSS REFERENCE TO RELATED APPLICATIONS

This is a divisional application of the U.S. Ser. No. 09/554,463 related to an international application number PCT/DE98/03270 (WO 99/24294, European Patent EP 1 037 773 B1, German Patent DE 197 49 780 C2) filed Nov. 10, 1998.

### BACKGROUND OF THE INVENTION

1. Field of the Invention

It is an object of the present invention to adapt a belt-feeding device to the seat-design and, while preserving user-friendliness, to ensure the restraint of every passenger of a transport system and to lower all acceleration-dependent forces imposed on them in order to enhance the survival chance in the event of any accident (front-, side-, rear-end collision and/or rollover or pile up/mass collision) or during in-flight turbulence.

2. Discussion of the Prior Art

It is known in the prior art to provide for a passenger of a transport system

a three-point seat belt (safety belt or lap-shoulder seat belt assembly), mounted in the motor vehicle, consisting of a shoulder belt extending across the upper part of his body and of a lap belt extending across the lower part of his body; or

a two-point seat belt, mounted in the aeroplane, acting as a lap belt extending across the lower part of his body; or

a suspender-(waist-) belt consisting of several pieces (belt-members).

In order to formulate in single terminology a generalized definition is presented for the proper term:

| Definition: | Proper Term: |
|---|---|
| “Transport system” | Motor vehicle or train or ship |
| | or aeroplane |
| “Stiff first transport- | Floor 6 of the transport system |
| system member” | adjacent to a first seat-side |
| | SR (FIG. 1) or seat-cushion frame |
| | at the first seat-side or |
| | mid-tunnel (not drawn) of the |
| | motor vehicle adjacent to the |
| | first seat-side. |
| “Stiff second transport- | Floor 6 of the transport system |
| system member” | adjacent to a second seat-side |
| | SL or seat-cushion frame at the |
| | second seat-side or post section |
| | 91 (FIG. 13) of the motor vehicle |
| | adjacent to the second seat-side |
| | or side rail of the motor vehicle |
| | adjacent to the second seat-side |
| “Stiff third transport- | Floor 6 of the transport system |
| system member” | adjacent to the first seat-side |
| | or seat-backrest frame of the |
| | seat at the first seat-side. |
| “Stiff fourth transport- | Floor 6 of the transport system |
| system member” | adjacent to the second seat-side |
| | or seat-backrest frame at the |
| | second seat-side or post section |
| | adjacent to the second seat-side. |
| “Shoulder-belt-portion | Belt deflector 5, 5b or D-ring 12 |
| guiding deflector” | (FIG. 1) |

It is well known to provide different restraint systems in vehicles, predominantly, three-point seat belts in various types for seats. Evidently, when both shoulders of a passenger, conventionally belted, are not restrained in the event of an arbitrary collision with another vehicle in any direction, shown in FIGS. 3, 4 and 7, the unrestrained shoulder can always move and/or rotate freely, thereby resulting in severe/fatal injuries in real-world accidents when

the head crashes into the steering wheel and/or window pane and/or

the airbag crushes the head, which, loaded by the forces related to pitch-acceleration Ü_{H}, yaw-acceleration Ö, longitudinal and/or lateral acceleration, is in “oop” (out of position). Moreover, by the definition of _{“}submarining” the belted passenger submarines (slips downward) under his seat belt thus negating the protective effect of the seat belt.

It is well known to provide two-point or lap seat belts for aeroplane seats as well as mid-portion of the rear seats of motor vehicles. This lap seat belt is far less effective than a three-point seat belt. Due to very large accelerations during a turbulence-related flight the protective effect is very low.

A substantially improved protection is proposed by two different configurations of a one-piece seat belt, exemplified by DE 26 02 875 A1 (FIGS. 8 to 10). An _{“}X-shaped” restraint is arranged by extending both shoulder belts crosswise over the upper part of the body while the lower part of his body is restrained by the lap belt. Each end of the one-piece seat belt is connected to a belt retractor, fastened in the seat backrest. Two grab rings, positioned to the headrest, move along the belt. A single or double _{“}X-shaped” configuration is defined by pulling a pair of grab rings and belt portions over the head, shoulders and head rest and engaging them in the corresponding hooks. Due to such intricate operation the seat belt remains unused.

Both harness restraint systems ref. to U.S. Pat. Nos. 4,488,691 and 4,738,413 are well-known as suspender belts. Each belt portion of the suspender belt must always be adjusted to an appropriate length depending on the size of the passenger. In general, suspender belts are not popular because finding all the belt portions and connecting all the attachment ends to the release device is a lengthy process, especially in the dark. Moreover, all the belt portions make an untidy impression and are not beneficial for sales.

The biggest drawback is the failure of the restraint. When the belt force exceeds 24,000 N due to lack of energy absorbers in real-world accidents the passenger are severely/fatally injured. Moreover, he frees himself out of the restraint because the belt elongates at a force-dependant rate over 25%, shown in FIG. 6 of PCT/US99/13362 (U.S. Ser. No. 09/098,294). Despite being properly restrained and properly seated on a child-seat, perfectly secured to the rear seat, a six-year old kid freed himself out of the restraint and was ejected out of a Toyota Yaris, travelling at 100 km/h, when it laterally slammed into a concrete wall. The accident report “U211002” is incorporated herein.

Ref. to U.S. Pat. No. 4,738,413 the harness restraint system comprises a pair of shoulder belt portions, extending crosswise in an X-shape over the upper part of the body of a crew member, a pair of lower-body belt portions, laterally sustaining the lower part of the body, a pair of leg belt portions, encircling the legs and a single-point release device, which holds the attachment ends of all the belt portions and releases them in a single operation.

Ref. to U.S. Pat. No. 4,488,691 the harness restraint system comprises a pair of shoulder belt portions, extending crosswise in an X-shape over the upper part of the body of a crew member, a pair of leg belt portions, restraining the legs and a release device, which holds the attachment ends of all the belt portions and releases them in a single operation.

U.S. Pat. No. 4,652,053 discloses a safety belt system, comprising a pair of shoulder belt portions, restraining only the shoulders of the passenger by means of a pair of upper and lower attaching units, and a lap belt portion, restraining the lower part of the body by means of a lap attaching unit. A pair of rotatory members of the upper attaching unit, when rotated, adapts the distance between the shoulder belt portions to the shoulder width of the passenger. A pair of handling members of the lower attaching units, when rotated, adjusts the length of shoulder belt portions to perfectly restrain the shoulders. Only a butler, standing behind the passenger, could accomplish this time-consuming job. If the car catches fire, the passenger will be burnt alive. For sure, no car company would install such intricate, life-threatening systems.

U.S. Pat. No. 34,051 teaches a safety belt system, comprising a locking device, a pair of shoulder-, lap belt portions and pivot arms, having a pair of second wheels, meshing with the corresponding first wheels, connected to each other by a shaft, laterally located in the lower portion of the seat backrest. One end of each shoulder belt portion is arranged in the seat backrest on the top edge and the others are connected to the free ends of the lap belt portions by a male and female member of the locking device.

Ref to FIGS. 5 and 6 of U.S. Pat. No. 34,051 the cross section of the pivot arm is a little larger than that of the lap belt and the lap belt is arranged along in the pivot arm. This feature is redundant. The flexible pivot arms, serving as the lap belts, can take the function thereof Under the premise that the lap belts (pivot arms) fit the circumference of the passenger, he is restrained when the pivot arms, located at the sides of the seat backrest in the home position, are moved downwards into the operative position and the male and female members are connected to each other. Because each lap belt has a fixed length, the total length of the lap belts together is too short for an obese passenger and too long for a skinny passenger, who, being loosely restrained, is subjected to submarining. When the belt is loaded up to 24,000 N the wheels and/or the pivot arms are totally deformed.

DE-OS 23 45 847 addresses a height-adjustable upper belt deflector of a shoulder belt portion of a three-point seat belt. This deflector can be adapted to the height of the restrained shoulders of the passenger by means of a device, moved by a knob along the rails of the belt deflector. The overall stylish impression is spoiled by the belt deflector, rails and device with the knob, all mounted to the seat backrest, and is not beneficial to sales. Moreover, a passenger, sitting on a seat next the one that is equipped with the belt deflector, device and knob, is severely/fatally injured when his head crashes therein.

According to the Claim No 2 of DE-OS 28 13 888 a four-point seat belt for a passenger seated in the rear, defined by the shoulder and lap belt portion of a three-point seat belt and an upper shoulder belt, is made from one piece. Each belt is guided by a belt deflector, adjacent to the lower part of the body of the passenger, and fastened to the vehicle frame. The end portions of the shoulder belt portion and the upper shoulder belt are provided with belt retractors, attached to the seat backrest. In an attempt to step out the passenger has to lower the upper part of his body in order to slip underneath the upper shoulder belt which cannot be removed.

In order to enhance the convenience the belt deflector of the upper shoulder belt is replaced with a latch plate and a corresponding buckle assembly, fastened to the vehicle frame.

DE 196 29 878 A1 teaches a four-point seat belt, comprising two independent three-point seat belts, each having a belt retractor, latch plate, belt deflector and buckle assembly.

U.S. Pat. No. 3,977,696 discloses a four-point seat belt, comprising a three-point seat belt and an upper shoulder belt, both of which, provided with belt retractors, are guided in two rails and driven by electrical motors of a heavy device. When the vehicle roof is totally deformed in a rollover-accident the heavy device crushes the passenger into death.

U.S. 5,123,673 discloses a four-point seat belt, comprising a three-point seat belt and an upper shoulder belt, both of which are provided with belt retractors. An intricate, automatic release device facilitates the release of both buckle assemblies, each equipped with an actuator to release them, regardless of which one is manually released first. When an MB 200 crashes into the vehicle door of an MB S in the city of Geisenheim, a lateral intrusion of about 80 cm is measured. The accident report “U170199” is incorporated herein. When used, the buckle assembly, actuator and other parts, all of which face the totally deformed vehicle door, are destroyed. Hence, the other one does not function. The severely injured driver remains restrained.

A complicated latch-plate-feeding device, installed to the side of seat cushion, moves forwards to present the latch plate of the three-point seat belt to the passenger, after having sat down.

U.S. Pat. No. 5,411,319 discloses a four-point seat belt, comprising two independent three-point seat belts, having a common lap belt portion. Two end belt portions of both three-point seat belts are projected through the seat backrest and attached to a pair of belt retractors, provided with a pair of supporting pieces, which are arranged in a pair of seat rails, are retained thereby and are moveable therealong with the seat when the latter is longitudinally adjusted.

According to the above-mentioned patent docs U.S. Pat. Nos. 3,977,696, 5,123,673, 5,411,319, DE-OS 28 13 888 and DE 196 29 878 A1 the “X-shaped” configuration, formed by extending both belts crosswise over the upper part of the body, has, in general, the following drawbacks in the event of an accident:

D1. Both belts are retracted and blocked to different lengths by two independently operating belt retractors within milliseconds in an accident.

D2. Under the load of the same belt force in a front collision the deformation of the seat backrest, wherein both belt ends are fastened, is larger, thus increasing the forward motion. Furthermore, it is impossible to attach an energy absorber because all four belt ends are occupied.

D3. Exemplified in U.S. Pat. No. 5,411,319, the belt user has to depress two release buttons to release the respective main latch plates 9 from the main buckle assemblies. This two-click operation causes discomfort and hinders rescue work. See countermeasures by means of a single master release button, mentioned below.

A one-piece seat belt 1 (FIG. 1) ref to DE-OS 28 13 888 is equipped with two belt retractors (not drawn), fastened to both belt ends in the seat backrest, and a belt deflector 17, anchored to the seat-cushion frame 3.3 of the mid-portion of rear seat. The feature, proposed for a child, has the following drawbacks:

D4. When the release button 84 is depressed, the first shoulder belt portion 1.1 gets entangled around the neck of passenger. For the operation of restraining and extending both belt portions into the _{“}X-shaped” configuration, the passenger must lower his head first.

D5. Because all belt ends are occupied, it is impossible to attach energy absorbers and to adjust the belt to the size of an upper part of the body 95 of an adult.

Generally, a child-seat is fastened by four auxiliary belts to the seat. Despite the _{“}X-shaped” configuration of a one-piece seat belt to restrain a child, sitting in a child-seat, ref to FR 2 342 872 A1 the problems, associated with the retraction of four auxiliary belts, submarining and energy absorption, remain unsolved in an accident.

Till now, trains, school buses and buses are not provided with restraint systems.

### SUMMARY OF THE INVENTION

Accordingly, the principle object of the present invention is to provide for passengers of a transport system seat belts, each equipped with a belt retractor, solely responsible for retraction, blocking and tightening or for protraction, a lower belt deflector to loosely guide a belt portion and multi-attachment points (multi-points of restraint), and to restrain every passenger in multi-attachment points, in order to lower and distribute the acceleration-dependent loads, shown in FIG. 3 and Tables 1 to 3, to the multi-attachment points in the event of any accident or during in-flight turbulence. Nowadays, belt tighteners are incorporated into belt retractors, for example, of MB 500 SL in order to save costs, assembly time and space.

A second object of the present invention resides in an integration of a belt-feeding device in a seat, shown in FIGS. 12a to 12f, in a user-friendly belt-feeding device to ease the restraint and serve as a protective-rollover device, shown in FIG. 17, as well as in comfort enhanced by one-click operation by means of a single master release button, which, when depressed, releases all latch plates from the buckle assemblies and/or returns the belt-feeding device to the home (resting) position. In emergency cases paramedics and fire-fighters can easily rescue the injured passengers.

A third object of the present invention resides in the conventional three-point seat belt associated with new parts, shown in FIG. 2, to serve as a transition product until multi-point seat belts are put into production.

### INDUSTRIAL APPLICABILITY

It should be apparent that the invention provides substantially improved restraint, including the following features:

a) The survival chance is enhanced by the restraint of

* both shoulders and the torso, when the passenger is thrown forward (FIG. 4, Table 3) and/or subjected to the yaw Ö-acceleration-dependent torque T_{ö}, and

* both thighs and the lower part of the body to prevent submarining (FIGS. 14, 15).

b) Because the belt retractor is attached to one belt end, a number of sets of vibration-dampening energy absorbers ref. to U.S. Ser. No. 09/554,464 (WO 99/24292, PCT/DE98/03271, European Patent EP 1 037 771 B1, German Patent DE 197 58 498 C2, CA pending patent 2,314,345) or German Patent DE 197 58 497 C2 can be attached to the other belt end (FIGS. 11a to 11c), thus gradually absorbing large impact energy below the respective injury-related values. The inventor of the present application has submitted those patent documents and applications to CIPO as well as USPTO. The vibration-dampening energy absorber consists of a number of clamping elements, having sites of predetermined fracture, and a retaining element, which, fastened to the seat-backrest frame and/or seat-cushion frame, can serve as an integral part thereof.

c) Owing to the different positions of pairs of upper buckle assemblies, in plug-in connection with the respective belt-detachable latch plates 25 (FIG. 17), passengers of different body proportions can adjust the belts by themselves. Moreover, the seats, equipped therewith, can be modified to be used by adults or children, thus increasing the rate of seat occupancy in a bus, train or an aeroplane, exemplified in FIG. 15.

d) In resting position the shoulder latch plate 2, in plug-in connection with an assisting buckle assembly 16, 16a, 16b, fastened to the seat cushion 3.1, B-, C-post section or seat backrest (FIGS. 1, 2), is easily accessed by the passenger wanting to use the belt.

e) The seat belt can be equipped with a belt-feeding device, manually operated or by a drive apparatus, for example, hydraulic-piston cylinder unit, electrical motor (not drawn), which enhances the convenience and comfort of the user. This drive apparatus is switched on by a pressure sensor, built to the seat, or an existing switch such as lighting-, door- or touching switch. If the belt is not engaged within a dwell time, a control device is activated to switch off the drive apparatus and to reposition the belt-feeding device in the resting position.

f) For the convenience of the passenger, when stepping out, or for the quick-rescue of the injured passenger in accidents, the master release button 84 of the buckle assembly 9.1 is depressed to release all latch plates from the buckle assemblies and/or to return the belt-feeding device to the resting (home) position.

g) The round rollover tubes 20.2b of the seat backrest frame 3.4d are designed to guide the belt housing 20.4c, 20.4d (FIGS. 16, 17), to act as safety bars in a rollover and to allow free view to the rear owing to openings 97R, 97L (FIG. 15).

### BRIEF DESCRIPTION OF THE DRAWINGS

A number of embodiments, other advantages and features of the present invention will be described in the accompanying tables and drawings with reference to the xyz global coordinate system:

Table 1 shows test data such as left/right thigh-force, belt force and pitch-angle of driver and co-driver in 50% offset crash test of several European vehicles at crash speed of 55 km/h.

Table 2 shows yaw angle O of driver/co-driver in a 50% offset crash tests.

Table 3 shows test data of the safest child-restraint system Chico Shuttle® at the converted velocity of 55 km/h in comparison with the safest vehicle among them listed in Table 1.

FIG. 1 is a perspective view of a seat with buckle assemblies attached to the seat backrest and seat cushion as well as of a 1st embodiment of a restraint system consisting of a multi-point seat belt 1, shoulder-belt-portion guiding deflector 5, D-ring 12, latch plate 11 moveable along the lap belt, shoulder latch plate 2 of belt end portion, in the direction of arrow _{“}Z” in plug-in connection with an upper buckle assembly 4, and a seat belt in X-shape, formed by crossing the first and second shoulder belt portions 1.1, 1.2.

FIG. 2 is a perspective view of a seat and of a 2nd embodiment of a restraint system comprising three-point seat belt 1e having a transition latch plate 2, which will be inserted into a transition buckle assembly 4e of a shoulder belt 1.11, pulled in the direction of arrow _{“}Z”.

FIG. 3 illustrates load cases I, II and III in z-y plane in the event of a real-world accident.

FIG. 4 is a perspective view of a restrained dummy thrown forward in VW Polo® in a 50% offset crash test.

FIG. 5 illustrates a yaw-acceleration Ö and yaw-angle O of a vehicle about the vertical axis _{“}z_{A}” in a 50% offset crash test of two identical vehicles.

FIG. 6 illustrates a yaw angle O of vehicle about the vertical axis _{“}z_{A}” in a 50% offset crash test into a stiff barrier.

FIG. 7 illustrates four collision types _{“}U1” to _{“}U4” ref. to the research work of Institute of Vehicle Safety, a Dept. of German Insurers Association.

FIG. 8 is a front view of a seat belt ref. to DE-OS 26 02 875 in the home position.

FIG. 9 is a front view of a double X-shaped seat belt ref. to DE-OS 26 02 875.

FIG. 10 is a front view of a single X-shaped seat belt ref to DE-OS 26 02 875.

FIG. 11a is a schematic, perspective view of a 1st embodiment of a buckle assembly 4a, equipped with release cable 4.2.

FIG. 11b is a schematic, perspective view of a 2nd embodiment of a buckle assembly 4b, equipped with an electrical release-motor 4.2b.

FIG. 11c is a schematic, perspective view of a 3rd embodiment of a buckle assembly 4c, equipped with a release cable 4.3.

FIGS. 12a to 12f are schematic, perspective views of a 1st embodiment of a belt-feeding device 20 in kinematics from the resting position to the operative position.

FIG. 13 is a schematic view of a 2nd and 3rd embodiment of spatially-adjusting belt-feeding devices 20a and 20b in kinematics from the operative position to the resting position in x-y plane.

FIG. 14 is a perspective view of the 1st embodiment of the belt-feeding device 20 of the seat belt.

FIG. 15 is a front view of the seat 3a to 3d, in which the restraint systems 1a to 1d are integrated, for passengers of different weights and body proportions (sizes).

FIG. 16 is a schematic, perspective view of a seat, equipped with rollover tubes 20.2b, and of a 4th embodiment of a belt-feeding device 20c.

FIG. 17 is a schematic, perspective view of a seat having rollover tubes 20.2b, a 5th embodiment of a belt-feeding device 20d, provided with a safety bracket 20.6, a height- and width-adjusting mechanism 27, 27a.

### DESCRIPTION OF THE PREFERRED EMBODIMENTS OF THE INVENTION

The advantages of the preferred embodiments in the Chap. “INDUSTRIAL APPLICABILITY” are outlined hereinafter with regard to the functions and features thereof

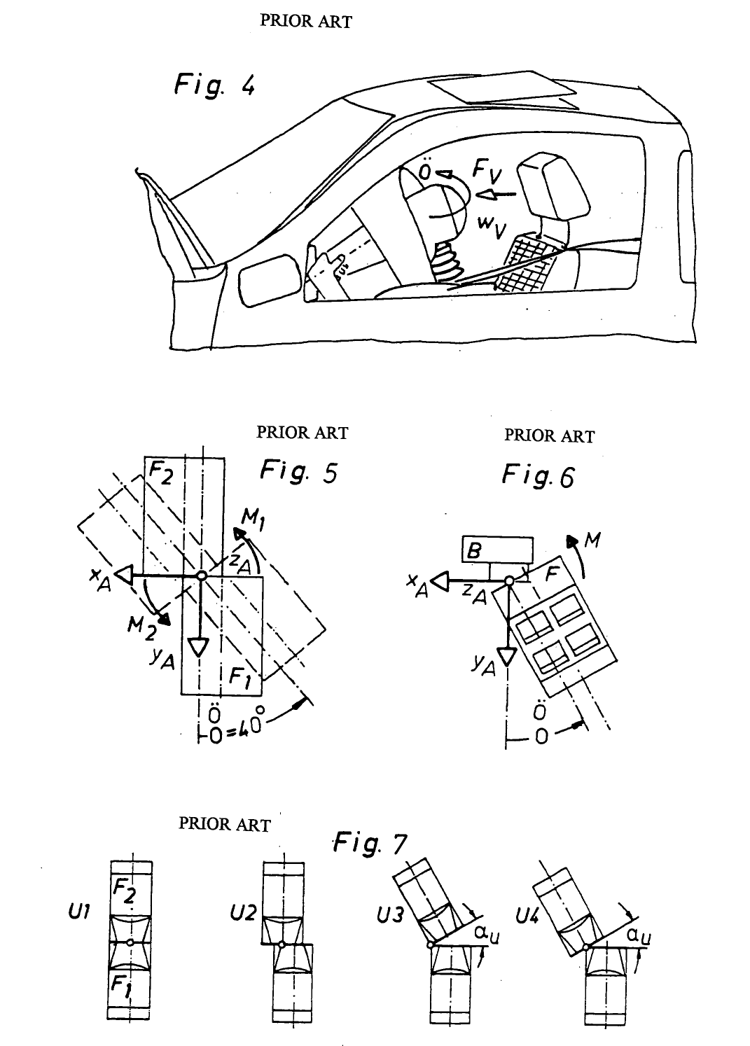

The method of the present invention capitalizes on the premise that a seat belt is employed to restrain a passenger in at least four attachment points of the seat to distribute all acceleration dependant loads, particularly the yaw Ö-acceleration-dependent torque T_{ö}, thereto in an accident, thus ensuring the operation of a single belt retractor to pre-tension (bias) as well as tension the belt, restraining both shoulders, upper- and lower part of the body and lowering all the loads, in particular, in co-operation with the energy-absorption when a number of sets of vibration-dampening energy absorbers is put into use. This will be apparent when all forces, imposed on the belted passenger, shown in FIGS. 3 and 4, are formulated in the event of a front collision, where the loads of the mass Dₛ of the torso are lowered because

the forward motion _{“}wᵥ” is minimized, thus substantially reducing the pitch-acceleration Ü_{H} and force F_{Hy} of the mass D_{H} of the head, and

the yaw-acceleration Ö is minimized, thus substantially reducing the torque T_{ö}, imposed on the head. Great torque T_{ö}, is the most latent force, responsible for sudden death.

To a great extent massive head injuries can be avoided.

Load case I in z-y plane: The rotating mass Dₛ rotates about the rotating axis _{“}S” at the pitch-angle U_{S} and mass D_{H} about the rotating axis _{“}z” at the pitch-angle U_{H} in Table 1, thereby resulting in the pitch-accelerations Ü_{S}, Ü_{H} and rotating forces F_{Sy}, F_{Hy}. The addition of both rotating forces yields the force F_{V} linked to the forward motion w_{V} of passenger, shown in FIG. 4.

Load case II in x-y plane: The upper part of the body is subjected to the torque T_{ö}, exerted by the yaw-acceleration Ö about the rotating axis _{“}z”. When the upper part of the body is restrained in an X-shape, the torque is substituted by a pair of forces.

Load case III in x-z plane: The rotating mass D_{S} rotates about the rotating axis _{“}S” at the rotating angle U_{y}and mass D_{H} about the rotating axis _{“}z” at the rotating angle U_{Hy}, thereby resulting in the rotating accelerations Ü_{y}, Ü_{Hy} and rotating forces D_{Sy}, D_{Hy} (not drawn). In a rollover-accident the passenger is subjected to the load F_{Sz}.

Load case IV: In turbulence-related vibrations of an aeroplane the load D_{Sy} together with D_{Hy} takes the form of periodical load ±F_{Hx}, F_{Sz} of ±F_{Sz}, T_{ö} of ±T_{ö}, S_{y} of ±S_{y} and F_{Sy} together with F_{Hy} of ±F_{V}.

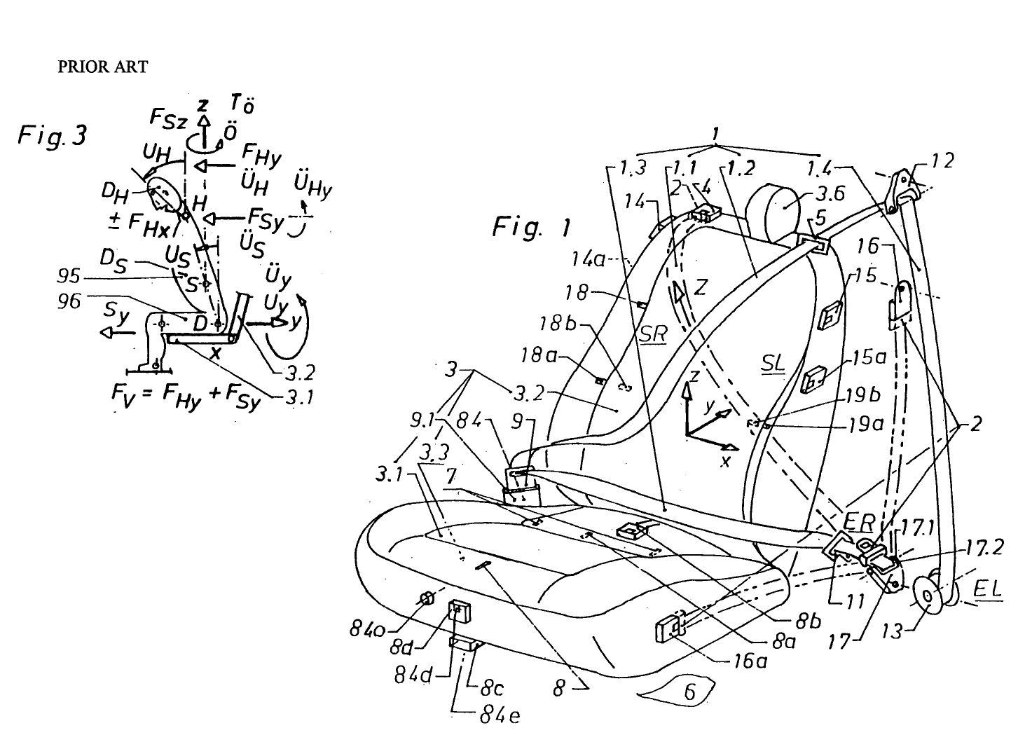

The restraint system, illustrated in FIG. 1, is provided with a conventional belt retractor 13 having a clamping device, housed in the B-, C-, D-post section or in the seat backrest 3.2 at one of both seat-sides SL and SR of a seat and connected to the second belt end EL. The first belt end ER is provided with a shoulder latch plate 2, which is retained, loosely guided by a lower belt deflector 17, fastened to the vehicle floor, and inserted into one of the upper buckle assemblies 4, 4a to 4c, 14, 14a, 18, 18a, 18b, arranged in or to the seat backrest 3.2. In all embodiments a main latch plate 9 can move along the seat belt 1 between both belt ends EL and ER. When plug-in connecting the shoulder latch plate 2 (in the direction of arrow “Z”) to the buckle assembly 4 and the main latch plate 9 to the main buckle assembly 9.1, an X-shaped restraint of the upper part of the body and both shoulders as well as a restraint of the lower body are accomplished by the first and second shoulder belt portion 1.1, 1.2 and the lap belt portion 1.3.

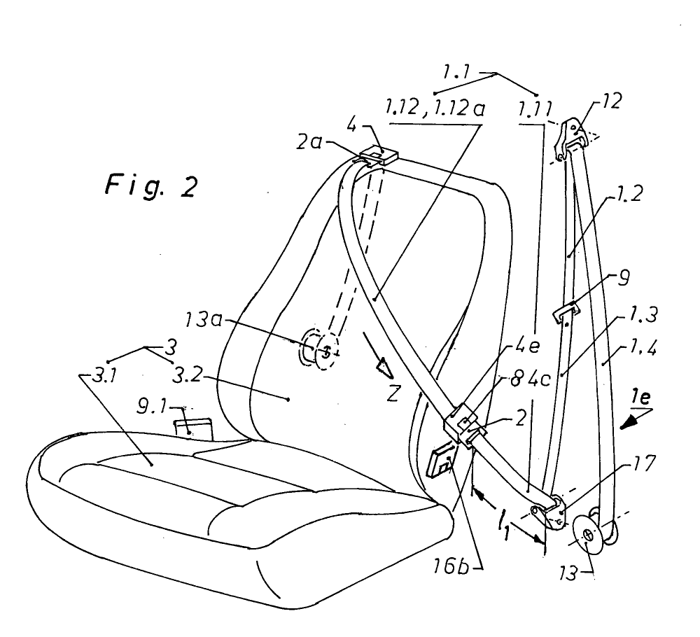

In the 2nd embodiment, shown in FIG. 2, a transition product, comprising a conventional three-point seat belt 1e and new parts, has to be invented due to the delay in producing multi-point seat belts 1. The floor fitting (not shown) is replaced by the lower belt deflector 17. The first belt end of the lower first shoulder belt portion 1.11 is provided with transition latch plate 2. The first belt end of an upper first shoulder belt 1.12 and the second belt end are equipped with a transition buckle assembly 4e, having a transition release button 84c, and with a second belt retractor 13a, arranged in the seat backrest 3.2. Due to the second belt retractor the transition buckle assembly 4e, acting as the shoulder latch plate 2, 2a of multi-point seat belt, is located in a home position on a seat-backrest aperture of the seat at the first seat-side. Hence, the seat-design is not compromised. In a coupling position the restraint in an X-shape is defined by plug-in connection of transition latch plate 2 with the transition buckle assembly 4e, pulled out from the seat-backrest aperture, wherethrough a transition portion of the upper first shoulder belt is projected. This upper first shoulder and the lower first shoulder belt portion 1.11 define the first shoulder belt portion 1.1. In order to resolve the above-mentioned drawback D1, the spring force of the second belt retractor 13a, to retract the upper first shoulder belt 1.12, released by depressing the transition release button 84c, is far less than that of the belt retractor 13. Although the circumference of the restrained passenger varies, depending on the clothes worn, and the seating-position differs the lower first shoulder belt portion 1.11 always projects through the lower belt deflector 17 at a sufficient length of “1₁” to maintain the function of the belt retractor 13 to retract, to block the belt as well as to release the retracted belt during the journey and the function of the belt tightener (not drawn), incorporated in the belt retractor, to forcefully retract (withdraw) and tighten the belt in an accident. The transition release button 84c of transition buckle assembly 4e, arranged to or in the seat, can be controlled neither by release cable 4.2 nor by electrical release-motor 4.2b. It can only be activated by electrical signals emitted from the master release button 84 when depressed.

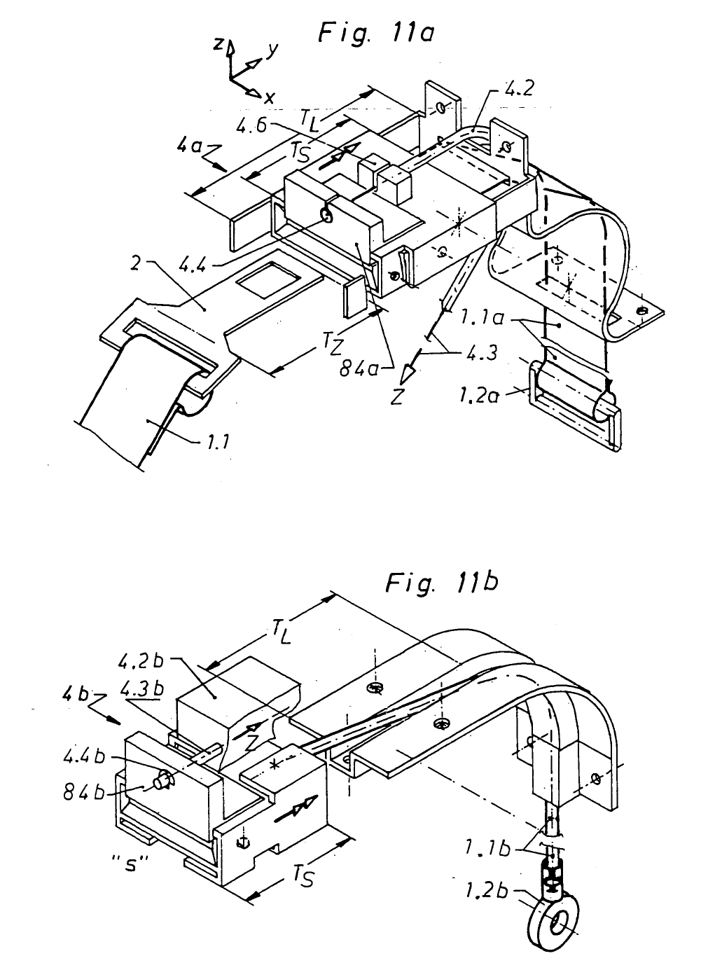

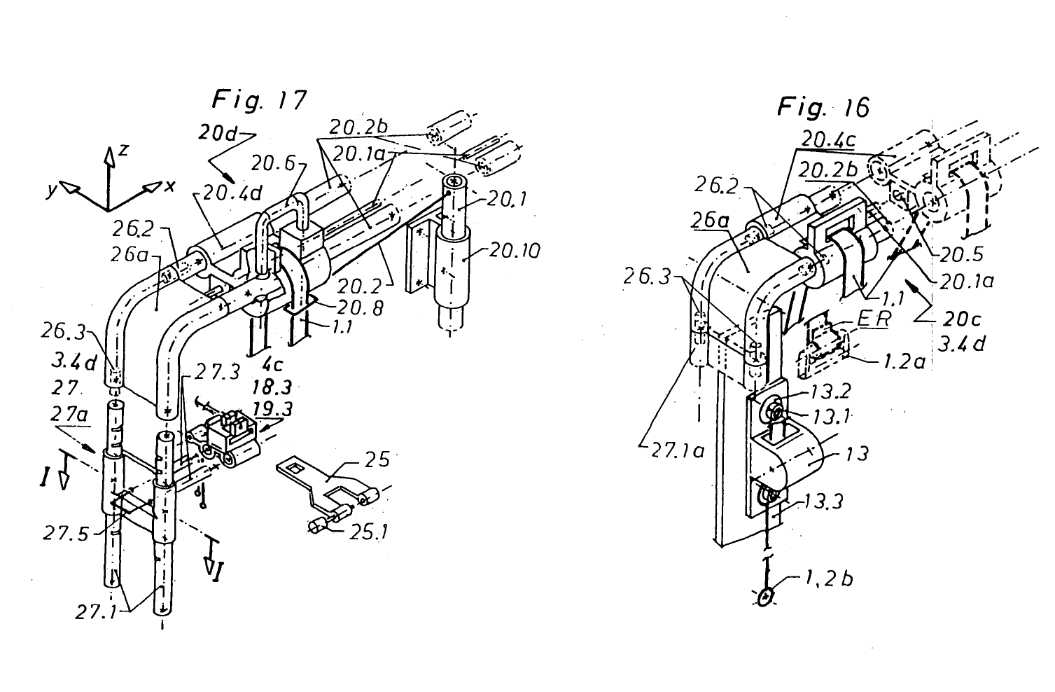

The second belt end of upper first shoulder belt 1.12 can be connected either to a coupling fitting 1.2a, 1.2b, 1.2c (FIGS. 11a to 11c) or to the second belt retractor 13a having a coupling fitting 1.2b (FIG. 16) in order to receive a number of vibration-dampening energy absorbers to dissipate great impact energy and dampen strong vibration.

In another embodiment an upper first shoulder belt 1.12a consists of the transition buckle assembly 4e and a shoulder latch plate 2a (not shown), similar to latch plate 2 (FIG. 1), which is plug-in connected to

the upper buckle assembly 4, 4a to 4c, 14, 14a, 18, 18a, 18b, 18.1 to 18.3, arranged to the seat backrest, in operative position or

the assisting buckle assembly 16, 16a, 16b in resting position.

When motor vehicles are already licensed, modification of different seats and three-point seat belts can easily be accomplished by arrangement of at least one buckle assembly, the lower belt deflector 17, the second belt retractor 13a and by a variety of one-piece, detachable, upper first shoulder belts 1.12a with different lengths. Furthermore, the latch plate 2a can be detached from the buckle assembly by depressing the master release button 84.

A first shoulder belt portion 1.1 is defined by the upper first shoulder belt 1.12a and the lower first shoulder belt portion 1.11.

With an expensive modification or in new transport system the convenience and comfort are enhanced by the use of belt-feeding device 20, 20a to 20d, where the upper first shoulder belt 1.12, 1.12a with transition buckle assembly 4e is a part of the belt-feeding device.

Beyond doubt, the three-point seat belt 1e in plug-in connection with the upper first shoulder belt 1.12, 1.12a is suited as a temporary solution for the multi-point seat belt 1, 1a to 1d.

In the above-mentioned embodiments to resolve the above-mentioned drawback D4 the upper part of the body is restrained by extending the shoulder belt portions crosswise in an X-shape when the belt-feeding device 20, 20c, 20d positions the first shoulder belt portion 1.1, the belt end ER of which is arranged to or in the side SR of the seat backrest, from the operative position to a resting position. This feature has the advantage that the common practise to operate the conventional three-point seat belt is preserved.

In order to resolve the above-mentioned drawbacks D2 and D5 great energy is absorbed and strong vibration is dampened by a large number of vibration-dampening energy absorbers connected to the respective upper buckle assemblies 4, 4a to 4c, 4e, 7, 8, 8a to 8d, 9.1, 14 , 14a, 15, 15a, 18, 18a, 18b, 18.1 to 18.3, 19, 19a, 19b, 19.1 to 19.3 (FIGS. 1, 15) to which latch plates are plug-in connected.

The lower belt deflector 17 comprises a housing having an attachment hole to receive a pin 17.1. Both members can be made in one piece. If necessary, the pin 17.1 is surrounded by a sleeve 17.2 of plastics, having corrugation or knobs, which is a common part of the conventional D-ring 12. This D-ring 12 can be replaced by the lower belt deflector 17. The aperture of the belt deflector 17 to loosely guide the belt portion is dimensioned so as to retain the latch plate 2 in resting position, thus allowing the use as a three-point seat belt.

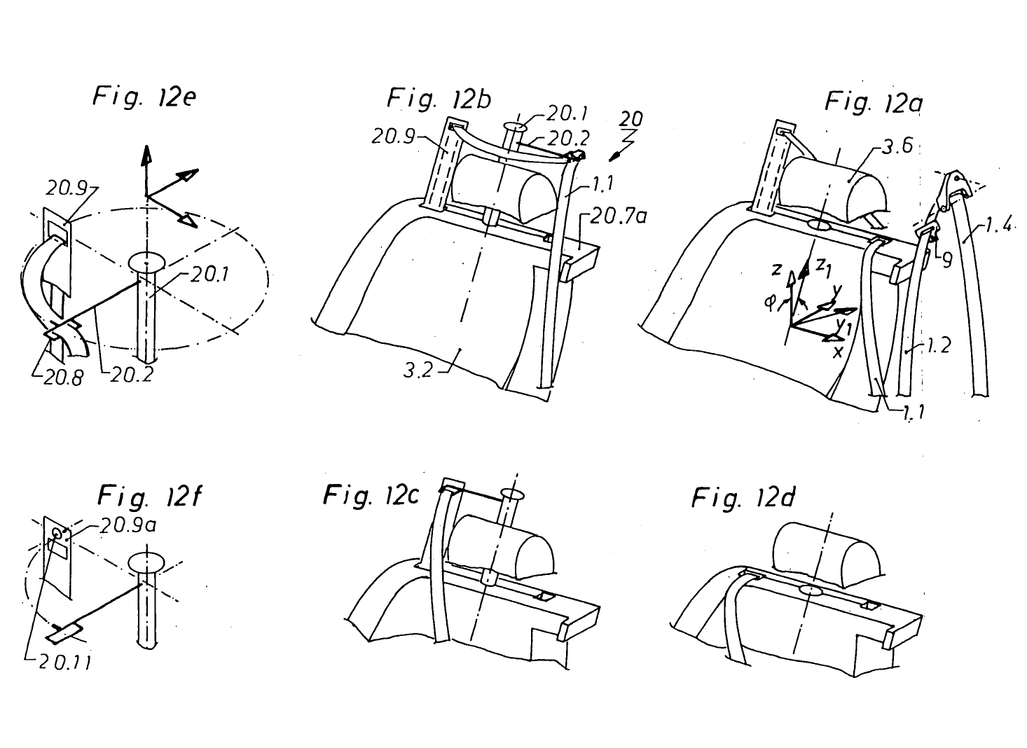

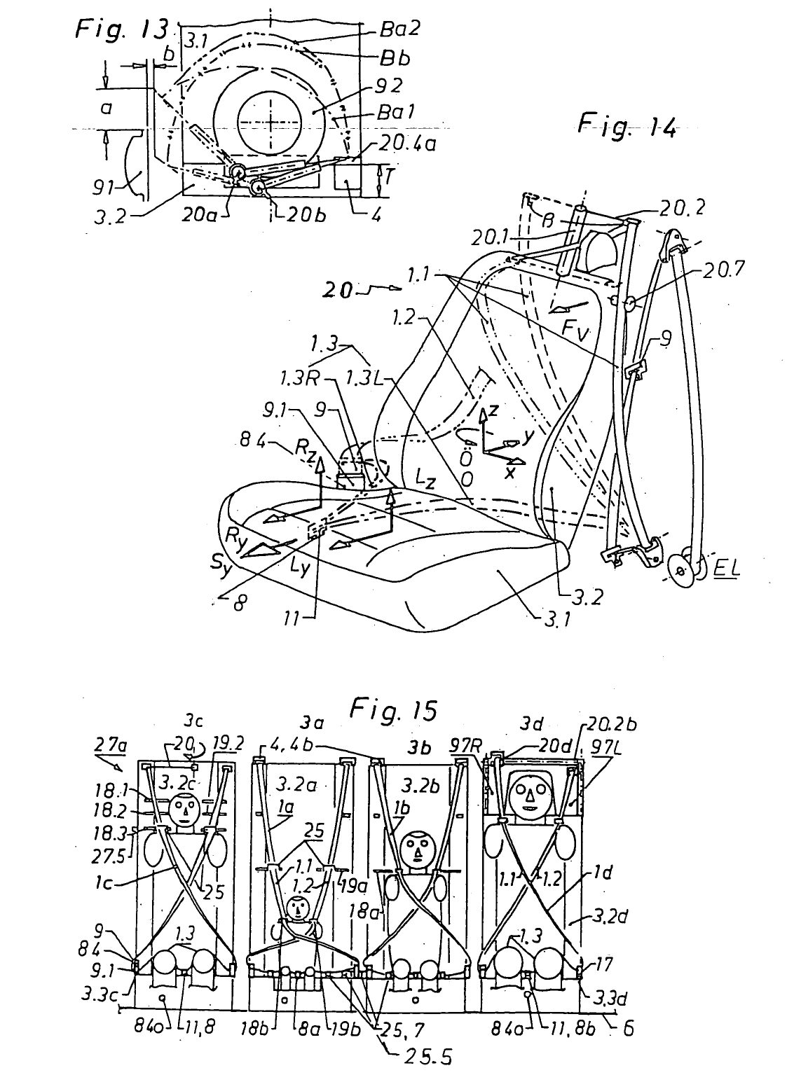

In the 1st embodiment ref to FIGS. 14, 12a, 12d the belt-feeding device 20 in resting position is provided with a device to countersink the belt-feeding plate 20.9 and the guide tube 20.1 with the operating arm 20.2 in the seat backrest to improve the overall impression of the seat-design, whereon the sales success depends.

When the passenger takes his seat, a drive apparatus, being activated,

moves up over the head rest a contact portion of the belt-feeding plate 20.9, moveable in an opening of the seat backrest (FIG. 12a), out of the opening and then the guide tube 20.1 with the operating arm 20.2, whose belt ring 20.8 houses and loosely guides the first belt portion 1.1 (FIG. 12b);

rotates the operating arm and the first shoulder belt portion over the head rest, his head and in front of the upper part of his body 95 at _{“}β” (FIG. 14), where in a contact position a key of the operating arm projects through a receptacle of the contact portion of the belt-feeding plate 20.9 or a clamping receptacle 20.11 of the belt-feeding plate 20.9a (FIGS. 12c, e, f); and

countersinks the contact portion of the belt-feeding plate 20.9 or 20.9a and the guide tube 20.1 with the operating arm 20.2 until reaching the operative position in which the first shoulder belt portion extends across over the upper part of his body and the drive apparatus is switched off(FIG. 12d).

To prevent the entanglement of the first shoulder belt portion 1.1 behind the seat, particularly when positioned furthest forward, that first shoulder belt portion 1.1 in resting position is intercepted by the belt-catching member 20.7, 20.7a (FIGS. 14, 12a, 12b). When the second shoulder belt portion 1.2 and the extending belt portion 1.4 are arranged to the post section, both shoulder belt portions can also be intercepted by the belt-catching member.

When the seat 3c (FIG. 15) has a high seat backrest, the curved guide tube 20.1 of belt-feeding devices 20x (not drawn) can be modified to a straight-running operating arm 20.2 of the belt-feeding device 20 (FIGS. 12a to 12f).

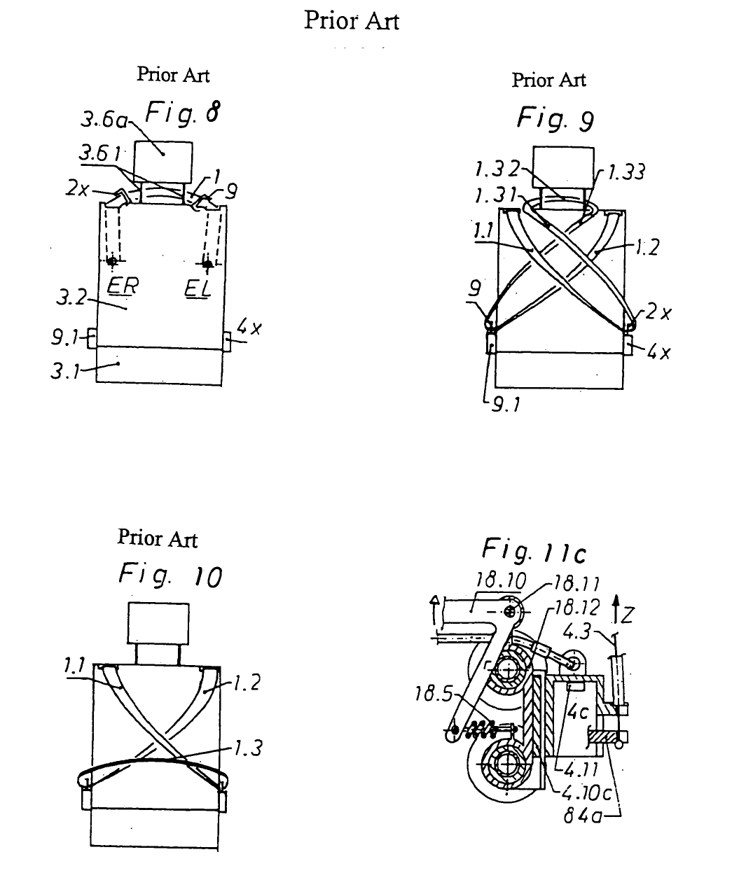

In order to ensure the operation of pro- and retracting any shoulder-belt portion, arranged in the seat backrest (FIGS. 8 to 10), is loosely guided by a shoulder-belt-portion guiding deflector which, having a rectangular shape, is usually pressed in a seat-backrest aperture of the seat backrest on the top edge.

The belt-feeding devices 20a, 20b have to meet the following criteria:

Passengers can freely get in and out of the vehicle compartment thanks to the distances of _{“}a” and _{“}b” between the post section 91 and operating arm 20.2a (FIG. 13) in resting position; and

the device, when rotated, does not interfere with the head rest 3.6 (FIG. 12b) owing to clearance (height-difference) and with the head of the passenger with/without hat 92.

Regarding the kinematics of the height-adjustable belt housing 20.4a with the latch plate 2 from the operative position to the resting position, the trajectories of _{“}Ba2” and _{“}Bb” are well clear of the passenger's head thanks to a radial-adjustable tube 20.3 incorporated into the operating arm 20.2a. Without the radial-adjustable tube 20.3 the operating arm in the trajectory of _{“}Ba1” would interferes with that hat.

In the 4th and 5th embodiment ref to FIGS. 16, 17 the belt-feeding devices 20c, 20d differ from each other by the rotatory movement of the operating arm 20.2, whose guide tube 20.1 is pivotally attached to a bearing casing 20.10. Preferably, upon the rotation about the head, the translatory and rotatory movement of belt are synchronised.

To form the upper part of the seat backrest frame 3.4d a pair of angle fittings 26a, a pair of rollover tubes 20.2b and a pair of side girders 27.1a or four tubes 27.1 (not drawn) are form- and/or force-locking connected to each other by connecting pins 26.2, 26.3 (drawn with dotted lines) and/or by welding, bolting, gluing and/or riveting. The belt housing 20.4c or 20.4d, having a moveable safety bracket 20.6, is guided by rollover tubes 20.2b and driven by an electrical motor 20.5 along the threaded spindle 20.1a, fastened to both angle fittings 26a, from the resting position (drawn with dotted lines) to the operative position, and back again. In the operative position the holes of the rollover tube 20.2b and belt housing 20.4d are aligned with each other, thus permitting the legs of the safety bracket 20.6, loaded in the event of rollover of a convertible, roadster or sport-utility vehicle, to project therethrough and clamp or jam the first shoulder belt portion 1.1.

Upon plug-in connection of the latch plate 2 with the buckle assembly 4, 4a, 4b the belt end ER of belt portion 1.1 is connected to the coupling fitting 1.2a, 1.2b (FIGS. 11a, 11b), whereto a number of energy absorbers is attached to absorb energy. In a cost-saving embodiment without the latch plate 2 and buckle assembly, the belt end ER of belt portion 1.1 is directly connected to the coupling fitting 1.2a or 1.2b (FIG. 16) to receive energy absorbers, the retaining elements of which are fastened to the seat backrest frame 3.4d. In order to absorb great energy and damp strong vibration during in-flight turbulence or in the accident of a fast speeding car or high-speed train, the belt retractor 13, coupling fitting 1.2b of which is connected to energy absorbers, is moveable attached to the oblong holes of a stiff plate 13.3, fastened to the seat-backrest frame at the side SR so that the other belt end EL can be exploited to receive additional energy absorbers. In excess of threshold value the belt retractor pulls the clamping elements along the respective retaining elements to absorb energy and damp vibration.

In the 1st to 3rd embodiment (FIGS. 11a to 11c) the buckle assembly 4a, 4b, 4c is form- and/or force-locking connected to the seat-frame of the seat.

For the convenience of the passenger when egressing from the vehicle and in cases of emergency the following embodiments of detachment are proposed:

To disconnect the latch plates 2, 11 and/or 25 from the buckle assemblies 4, 14, 14a, 15, 15a (FIG. 1) and pairs of supplement upper buckle assemblies 18/19, 18a/19a, 18b/19b, 18.1/19.1 to 18.3/19.3 (FIG. 15) of the seat arrangement, particularly for children, as well as from the anti-submarining buckle assemblies 7, 8, 8a to 8d (FIGS. 1, 14), the master release button 84, when depressed, activates the release cables 4.2 and/or electrical release-motors 4.2b, which pull the release button 84a and/or 84b of the buckle assemblies (FIGS. 11a to 11c). When depressing the master release button 84 the drive apparatus of the belt-feeding device 20, 20a, 20b returns the first shoulder belt portion 1.1 from the operative position to the resting position.

Belt-detachable U-shaped latch plates 25 offer the passengers a feature to adapt their body proportions to the appropriate pair of supplement upper buckle assemblies into which the latch plates 25 are inserted (FIGS. 15, 17). Any belt portion, such as 1.1, 1.2, is loosely guided thereby, secured by a quick-release pin 25.1 thereof and detached therefrom by pulling the quick-release pin. To adapt a small body proportion of, say, a child, far lower than the upper buckle assembly 4 suited for adults, at least one pair of belt-detachable latch plates 25 are plug-in connected to one of the pairs of supplemental upper buckle assemblies 18/19, 18a/19a, 18b/19b, 18.1/19.1 to 18.3/19.3, arranged to the seat backrest at the first and second seat-side (FIGS. 1 and 15). For safety reasons and easy access the belt-detachable latch plates 25, when not being used, are stored and secured in a storage box 25.5 of the seat (FIG. 15).

Although the present invention has been described and illustrated in detail, it is clearly understood that the terminology used is intended to describe rather than limit. Many more objects, embodiments, features and variations of the present invention are possible in light of the above-mentioned teachings. Therefore, within the spirit and scope of the appended claims, the present invention may be practised otherwise than as specifically described and illustrated.

TABLE 1

| | left / right | left / right | belt-force of | |
|---|---|---|---|---|
| | femur-force of | femur-force of | driver / co- | |
| | driver | co-driver | driver | U_{H} |
| Fiat Tipo ® | 15190 N | nR N | 5620 / 6100 N | 20 / 80⁰ |
| Opel Corsa ® | 2258 / 2700 | 1381 / 2315 | 7030 / 7310 | 25 / 90 |
| VW Polo ® | 2785 | 1587 | 5142 / 5655 | 45 / 70 |
| Fiat Bravo ® | 3700 | 2300 | nR / 6800 | 10 / 45 |
| VW Golf ® | 2340 | 1630 | 6040 / 7050 | 50 / 50 |
| MB C ® | 6858 | 2362 | 6015 / 6685 | 20 / 30 |
| MB E200 ® ohne | 1480 | 2140 | 8220 / 8380 | / |
| Airbag | | | | |
| VW Passat ® | 1600 | 2100 | 3400 / 4700 | 20 / 40 |
| AUDI A6 ® | 700 / 1200 | 1500 / 1100 | 6900 / 8400 | 25 / 50 |
| Opel Omega ® | 2750 | 2180 | 6580 / 6160 | nR / 40 |
| BMW 528i ® | 1400 / 1200 | 900 / 1300 | 3600 / 3400 | 10 / 30 |
| MB E320 ® | 2200 / 1700 | 1200 / 900 | 3000 / 3800 | 5 / 30 |
| AUDI A8 ® | 2360 | 2610 | 9130 / 8510 | 40 / 50 |
| BMW Z3 ® | 1300 / 1400 | 1300 / 900 | 8300 / 4400 | 0 / 10 |
| MB SLK ® | 5100 / 1700 | 800 / 4400 | 3300 / 3700 | 0 / 40 |
| FB | nR / 8300 | 2733 / 3980 | 6144 / 5415 | 5 / 85 |
| Renault Espace ® | 2037 / 11206 | 1323 / 1418 | 6829 / 7885 | 5 / 90 |
| Opel Sintra ® | 4100 | 4700 | 5300 / 6400 | 60 / 30 |
| VW Sharan ® | 2300 | 2600 | 6500 / 5700 | 35 / 70 |

FB = Peugeot 806 ®, Citroen Evasion ®, Fiat Ulysse ®, Lancia Zeta ®
nR = no result

TABLE 2

| | yaw O of |
|---|---|
| | driver / co-driver |
| BMW Z3 ® | 85 / 90⁰ |
| MB SLK ® | 100 / nR |

TABLE 3

| | | acceler- | acceler- | | |
|---|---|---|---|---|---|
| | force of | ation of | ation of | force of | forward |
| | head | head | chest | neck | motion |
| child-seat | 696 HIC | 65 g | 59 g | 1516 N | 552 mm |
| AUDI A4 ® | 392 | 49 | 45 | | |
| MB E320 ® | 229 | 38 | 40 | | |
| child-seat to | 304% | 171% | 148% | | |
| MB E320 ® | | | | | |

What is claimed:

1. A multi-point seat belt for increasing survival chance of a passenger of a transport system in an accident or during in-flight turbulence, comprising
a first and second shoulder belt portion, a lap belt portion and an extending belt portion (1.1 to 1.4) and a first and second belt end (ER) and (EL), where
the extending belt portion (1.4), loosely guided by a shoulder-belt-portion guiding deflector (5, 5b, 12) and having the second belt end (EL), is equipped with a belt retractor (13), having a clamping device and attached to a stiff fourth transport-system member, generally representing a floor (6) of the transport system adjacent to a second seat-side or a seat-backrest frame at the second seat-side or a post section of a motor vehicle adjacent to the second seat-side;
the first shoulder belt portion (1.1) has the first belt end (ER) and is attached to a stiff third transport-system member, generally representing the floor of the transport system adjacent to a first seat-side or the seat-backrest frame at the first seat-side;
a main buckle assembly (9.1), having a master release button (84) and attached to a stiff first transport-system member, generally representing the floor of the transport system adjacent to the first seat-side or a seat-cushion frame at the first seat-side or a mid-tunnel of the motor vehicle adjacent to the first seat-side;
at least one latch plate (2, 2a, 9, 11, 25);
a lower belt deflector (17), deflecting and loosely guiding the lap belt portion (1.3) or the first shoulder belt portion (1.1) and attached to a stiff second transport-system member, generally representing the floor of the transport system adjacent to the second seat-side or the seat-cushion frame at the second seat-side or the post section adjacent to the second seat-side or a side rail of the motor vehicle adjacent to the second seat-side; and
a belt-feeding device, provided with an operating arm (20.2), to a first end of which a belt ring (20.8) is rigidly attached to receive and loosely guide the first shoulder belt portion and a second end of which is connected to a guide tube (20.1), pivotally attached to a bearing casing (20.10) of the seat-backrest frame; whereby
a lower part of the body (96) of the passenger and an upper part of the body (95) are restrained by the lap- and second shoulder belt portions (1.3, 1.2) when the main latch plate (9), moveable along the lap- or second shoulder belt portion, is plug-in connected to the main buckle assembly (9.1); and
the upper part of the body is restrained by the first and second shoulder belt portions, both (1.1, 1.2) extending crosswise in an X-shape upon a rotatory movement of the operating arm with the first shoulder belt portion (1.1) from a resting position at the second seat-side to an operative position at the first seat-side.

2. The multi-point seat belt according to claim 1, further comprising at least one drive apparatus, which, provided for the belt-feeding device, when activated, rotates the operating arm with the first shoulder belt portion from the resting position to the operative position or vice-versa.

3. The multi-point seat belt according to claim 2, wherein the master release button (84), when depressed, releases the main latch plate and returns the belt-feeding device to the resting position.

4. The multi-point seat belt according to claim 3, wherein the master release button (84) is provided with a release wire connecting to the drive apparatus where the master release button, when depressed, releases the main latch plate from the main buckle assembly and returns the belt-feeding device to the resting position.

5. The multi-point seat belt according to claim 1, wherein the multi-point seat belt (1, 1a to 1d) consists of
a three-point seat belt (1e);
an upper first shoulder belt (1.12);
a first belt end of which is provided with a transition buckle assembly (4e), having a transition release button (84c), in a home position is located on a seat-backrest aperture of the seat backrest at the first seat-side; and
a second belt end is attached to the seat-backrest frame at the first seat-side; and
a transition latch plate (2), attached to a first belt end of a lower first shoulder belt portion (1.11) of the three-point seat belt (1e); whereby
in a coupling position the transition latch plate (2) is plug-in connected to the transition buckle assembly (4e), pulled out from the seat-backrest aperture, therethrough a transition portion of the upper first shoulder belt is projected, where the lower first shoulder belt portion (1.11) projects through the lower belt deflector (17) at a sufficient length (1₁) needed for the belt retractor to retract the first shoulder belt portion of the restrained passenger, defined by the lower first shoulder belt portion and the upper first shoulder belt, in the accident.

6. The multi-point seat belt according to claim 5, wherein the second end of the upper first shoulder belt (1.12) is provided with a second belt retractor (13a), which, attached to the seat-backrest frame at the first seat-side, has a spring force, which is less than that of the belt retractor (13), whereby
in the coupling position the belt retractor pulls the upper first shoulder belt out from the second belt retractor through the seat-backrest aperture or
in the home position the transition buckle assembly (4e), released by depressing the transition release button, is pulled by the second belt retractor until being located on the seat-backrest aperture.

7. The multi-point seat belt according to claim 5, wherein the transition buckle assembly is provided with an electrical release-motor (4.2b), which, when receiving an electrical signal from the main buckle assembly resulting from depressing the main release button releasing the main latch plate, pulls the transition release button to release the transition latch plate.

8. The multi-point seat belt according to claim 1, wherein the lower belt deflector (17) comprises a housing, having an attachment hole, and a pin (17.1), attached in the housing to form an aperture loosely guiding the belt portion.

9. The multi-point seat belt according to claim 8, wherein the pin (17.1) is surrounded by a sleeve (17.2).

10. The multi-point seat belt according to claim 9, wherein the lower belt deflector (17) is made from one piece.

11. The multi-point seat belt according to claim 3, further comprising
a key, rigidly attached to the belt ring of the operating arm; and
a belt-feeding plate (20.9, 20.9a), a contact portion of which, moveable in an opening of the seat backrest at the first seat-side and guided thereby, has a receptacle through which the key projects in a contact position and the operative position;
whereby the drive apparatus, being activated,
moves up over a head rest the contact portion of the belt-feeding plate out of the opening and the guide tube with the operating arm and with the first shoulder belt portion;
rotates the operating arm and the first shoulder belt portion over the head rest, a head of the passenger and in front of the upper part of his body until the key engages with the receptacle in the contact position and
countersinks the contact portion and the guide tube with the operating arm in the seat backrest until reaching the operative position in which the first shoulder belt portion extends across over the upper part of his body and, finally, the drive apparatus is switched off;
where in the operative position or in the resting position the contact portion of the belt-feeding plate and the guide tube with the operating arm are countersunk in the seat backrest.

12. The multi-point seat belt according to claim 11, wherein a radial-adjustable tube (20.3) is attached between the belt ring and the guide tube, where the first shoulder belt portion is moved from the resting position to the operative position by a radial-adjusting movement of the radial-adjustable tube when the drive apparatus is activated.

13. The multi-point seat belt according to claim 11, wherein the drive apparatus is operable to return the first shoulder belt portion (1.1) from the operative position to the resting position, when a dwell time, predetermined for an engagement of the key with the receptacle, is exceeded.

14. The multi-point seat belt according to claim 11, wherein the drive apparatus returns the first shoulder belt portion (1.1) from the operative position to the resting position, when a dwell time, predetermined for inserting the main latch plate into the main buckle assembly, is exceeded.

15. The multi-point seat belt according to claim 11, wherein the drive apparatus, activated in response to activating a switch, attached in the main buckle assembly (9.1), upon contact with a cam of the main latch plate (9), when inserted therein, is switched off when the operative position is reached.

16. The multi-point seat belt according to claim 11, wherein the drive apparatus, activated in response to starting an engine of the transport system, is switched off when the operative position is reached.

17. The multi-point seat belt according to claim 11, wherein the drive apparatus, activated in response to closing a vehicle door of the transport system, is switched off when the operative position is reached.

18. The multi-point seat belt according to claim 11, wherein the drive apparatus, activated in response to actuating a switch, is switched off when the operative position is reached.

19. The multi-point seat belt according to claim 11, wherein the drive apparatus is activated when the passenger takes a seat, whereto a sensor is built, where the drive apparatus is switched off when the operative position is reached.

20. The multi-point seat belt according to claim 11, wherein the drive apparatus, activated in response to depressing x-times the master release button (84), is switched off when the operative position is reached.

21. The multi-point seat belt according to claim 11, wherein the supplement latch plate is a belt-detachable latch plate (25), which has a quick-release pin (25.1) and a U-shaped portion to house the belt portion of the seat belt which is secured therein by the quick-release pin and detached therefrom by pulling it.

22. The multi-point seat belt according to claim 21, wherein the seat backrest at the first and second seat-side is provided with pairs of supplement upper buckle assemblies (18/19, 18a/19a, 18b/19b, 18.1/19.1 to 18.3/19.3),
one of which is adapted to a small body proportion of the passenger, lower than the upper buckle assembly, and,
finally, the belt-detachable latch plates, housing both shoulder belt portions, are plug-in connected to that pair.

23. The multi-point seat belt according to claim 22, wherein the belt-detachable latch plates, when not being used, are stored and secured in a storage box (25.5) of the seat.

24. The multi-point seat belt according to claim 22, wherein the upper buckle assembly is provided with a coupling fitting (1.2a, 1.2b) to receive energy absorbers.

25. The multi-point seat belt according to claim 22, wherein the master release button (84) is provided with release cables (4.2), connecting to release buttons of all the supplement upper buckle assemblies, and with a release wire, connecting to the drive apparatus, where the master release button, when depressed, releases all the latch plates from the respective buckle assemblies and returns the belt-feeding device to the resting position.

26. The multi-point seat belt according to claim 25, wherein a belt-catching member (20.7, 20.7a), attached to the seat backrest, intercepts and holds at least one shoulder belt portion when being in the resting position.

27. The multi-point seat belt according to claim 4, farther comprising
a pair of rollover tubes (20.2b), inserted into a pair of angle fittings (26a) of the seat-backrest frame (3.4d);
a belt housing (20.4d), which, moveable along the pair of rollover tubes and guided thereby, receives and loosely guides the first shoulder belt portion; and
an additional drive apparatus fastened to the belt housing and moveable along a threaded spindle (20.1a), fastened to the pair of angle fittings (26a);
whereby the first shoulder belt portion is moved from the resting position to the operative position by a translatory movement of the belt housing and the rotatory movement of the operating arm when both drive apparatus are activated.

28. The multi-point seat belt according to claim 27, wherein the translatory movement of the belt housing and the rotatory movement of the operating arm are synchronised.

29. The multi-point seat belt to protect the passenger in a rollover-accident according to claim 28, wherein the belt-feeding device (20c, 20d) serves as a protective-rollover device having the pair of rollover tubes (20.2b), along which the belt housing (20.4d), having holes to receive a pair of legs of a safety bracket (20.6), is moved in the operative position, where
holes of one of the rollover tubes (20.2b) and the holes of the belt housing are aligned with each other and
in excess of a threshold value in the rollover-accident the pair of legs of the safety bracket protrudes through all the holes, blocks the translatory movement of the belt housing and clamps the first shoulder belt portion (1.1).

30. A multi-point seat belt for increasing survival chance of a passenger of a transport system in an accident or during in-flight turbulence, comprising
a first and second shoulder belt portion, a lap belt portion and an extending belt portion (1.1 to 1.4) and a first and second belt end (ER) and (EL), where
the extending belt portion (1.4), loosely guided by a shoulder-belt-portion guiding deflector (5, 5b, 12) and having the second belt end (EL), is equipped with a belt retractor (13), having a clamping device and attached to a stiff fourth transport-system member, generally representing a floor of the transport system adjacent to a second seat-side or a seat-backrest frame (3.4d) at the second seat-side or a post section of a motor vehicle adjacent to the second seat-side; and;
the first shoulder belt portion (1.1) has the first belt end (ER) , attached to a stiff third transport-system member, generally representing the floor of the transport system adjacent to a first seat-side or the seat-backrest frame at the first seat-side;
a main buckle assembly (9.1), having a master release button (84) and attached to a stiff first transport-system member, generally representing the floor of the transport system adjacent to the first seat-side or a seat-cushion frame at the first seat-side or a mid-tunnel of the motor vehicle adjacent to the first seat-side;
at least one latch plate (2, 2a, 9, 11, 25);
a lower belt deflector (17), deflecting and loosely guiding the lap belt portion (1.3) or the first shoulder belt portion (1.1) and attached to a stiff second transport-system member, generally representing the floor of the transport system adjacent to the second seat-side or the seat-cushion frame at the second seat-side or the post section adjacent to the second seat-side or a side rail of the motor vehicle adjacent to the second seat-side; and
a belt-feeding device, consisting of
a pair of rollover tubes (20.2b), inserted into a pair of angle fittings (26a) of the seat-backrest frame (3.4d);
a belt housing (20.4d), moveable along the pair of rollover tubes from a resting position at the second seat-side to an operative position at the first seat-side, guided thereby, receiving and loosely guiding the first shoulder belt portion (1.1); and
a drive apparatus, fastened to the belt housing and moveable along a threaded spindle (20.1a), fastened to the pair of angle fittings (26a); whereby
a lower part of the body (96) of the passenger and an upper part of the body (95) are restrained by the lap- and second shoulder belt portions (1.3, 1.2) when the main latch plate (9), moveable along the lap- or second shoulder belt portion, is plug-in connected to the main buckle assembly (9.1); and
the upper part of the body is restrained by the first and second shoulder belt portions, both (1.1, 1.2) extending crosswise in an X-shape upon a translatory movement of the belt housing with the first shoulder belt portion (1.1) from the resting position to the operative position in response to the drive apparatus being activated.
